(19) United States
(12) Patent Application Publication
(10) Pub. No.: US 2018/0034945 A1
(43) Pub. Date: Feb. 1, 2018

(54) RADIO ACCESS ENTITY

(71) Applicant: Deutsche Telekom AG, Bonn (DE)

(72) Inventor: Gerd ZIMMERMANN, Weiterstadt (DE)

(21) Appl. No.: 15/659,639

(22) Filed: Jul. 26, 2017

(30) Foreign Application Priority Data
Jul. 29, 2016 (EP) 16181838.0

(51) Int. Cl. H04L 29/06; H04W 52/46; H04W 74/02; H04W 88/06

(52) U.S. Cl. CPC H04L 69/18; H04W 88/06; H04W 52/46; H04W 74/02; H04L 12/56

(57) ABSTRACT

A radio access entity for communicating with a mobile communication device via a radio access network includes: a first communication interface for receiving a data stream; a processor configured to split the data stream into a first sub-data stream and a second sub-data stream on the basis of a first efficiency level of a first communication port of the mobile communication device and a second efficiency level of a second communication port of the mobile communication device; and a second communication interface configured to send the first sub-data stream to the first communication port in a manner corresponding to the first data transmission technology and to send the second sub-data stream to the second communication port in a manner corresponding to the second data transmission technology.

### CROSS-REFERENCE TO RELATED APPLICATIONS

Priority is claimed to European Patent Application No. EP 16181838.0, filed on Jul. 29, 2016, the entire disclosure of which is hereby incorporated by reference herein.

### FIELD

The present invention relates to the radio access to a wireless communication network.

### BACKGROUND

In modern communication networks, communication packets are assembled according to a communication protocol, for example the Internet protocol. In the field of radio access, the communication packets are transmitted via radio to a mobile communication device using a wireless data transmission technology, such as Long-Term Evolution (LTE) or Universal Mobile Telecommunications Service (UMTS), or are received from the mobile communication device. Communication with the mobile communication device is usually carried out by a wireless data transmission technology, such as LTE.

A mobile communication device usually has, however, a plurality of communication interfaces or communication ports, such as wireless local area network (WLAN) and LTE or UMTS, which are not collectively used for the communication.

### SUMMARY

In an exemplary embodiment, the present invention provides a radio access entity for communicating with a mobile communication device via a radio access network. The mobile communication device comprises a first communication port which is compliant with a first data transmission technology and a second communication port which is compliant with a second data transmission technology. The radio access entity includes: a first communication interface for receiving a data stream; a processor configured to split the data stream into a first sub-data stream and a second sub-data stream on the basis of a first efficiency level of the first communication port of the mobile communication device and a second efficiency level of the second communication port of the mobile communication device; and a second communication interface configured to send the first sub-data stream to the first communication port in a manner corresponding to the first data transmission technology and to send the second sub-data stream to the second communication port in a manner corresponding to the second data transmission technology.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a communication system comprising a radio access entity;

FIG. 2 shows a mobile communication device; and

FIG. 3 shows a communication subnetwork.

### DETAILED DESCRIPTION

Exemplary embodiments of the present invention provide for efficient communication via a plurality of communication interfaces of a mobile communication device, for example a smartphone.

In an exemplary embodiment, the present invention provides for splitting a data stream coming from or travelling to the mobile communication device on the basis of the efficiency or performance of the communication ports of the mobile communication device. The sub-data streams are transmitted via the corresponding communication ports.

According to a first aspect, the invention relates to a radio access entity for communicating with a mobile communication device via a radio access network, wherein the mobile communication device comprises a first communication port which is compliant with a first data transmission technology and a second communication port which is compliant with a second data transmission technology, said radio access entity comprising a first communication interface for receiving a data stream, a processor configured to split the data stream into a first sub-data stream and a second sub-data stream on the basis of a first efficiency level of the first communication port of the mobile communication device and a second efficiency level of the second communication port of the mobile communication device, and a second communication interface configured to send the first sub-data stream to the first communication port in a manner corresponding to the first data transmission technology and to send the second sub-data stream to the second communication port in a manner corresponding to the second data transmission technology.

In one embodiment, the processor is configured to split the data stream into the first sub-data stream and the second sub-data stream on the basis of a ratio between the first efficiency level and the second efficiency level.

In one embodiment, the first efficiency level and the second efficiency level are data rates, bit error rates or performance indicators.

In one embodiment, the data stream comprises a plurality of data packets, wherein the processor is configured to assign a first number of data packets to the first sub-data stream and to assign a second number of data packets to the second sub-data stream.

In one embodiment, the first data transmission technology and the second data transmission technology are one of the following wireless data transmission technologies: LTE, UMTS, Global System for Mobile Communications (GSM), High Performance Radio LAN (HiperLAN) or WLAN.

In one embodiment, the second communication interface comprises a first communication port for sending or receiving the first sub-data stream and a second communication port for sending or receiving the second sub-data stream.

In one embodiment, the radio access entity is configured to receive information on the first efficiency level and the second efficiency level from the mobile communication device.

In one embodiment, the radio access entity is configured to measure the first efficiency level and the second efficiency level of the mobile communication device, in particular on the basis of at least one measurement signal.

In one embodiment, the radio access entity is a point-to-point communication subnetwork, in particular a slice, in 5G technology.

According to a second aspect, the invention relates to a mobile communication device comprising a first communication port for sending or receiving a first sub-data stream in a manner corresponding to a first data transmission technology, a second communication port for sending or receiving a second sub-data stream in a manner corresponding to a second data transmission technology, and a processor configured to assemble a data stream from the first sub-data stream and the second sub-data stream or to split said data stream on the basis of a first efficiency level of the first communication port of the mobile communication device and a second efficiency level of the second communication port of the mobile communication device.

In one embodiment, the processor is configured to split the data stream into the first sub-data stream and the second sub-data stream on the basis of a ratio between the first efficiency level and the second efficiency level.

According to a third aspect, the invention relates to a communication subnetwork in a communication network comprising a plurality of subnetworks, comprising the radio access entity according to the first aspect, wherein the second communication interface is configured to receive or send the first sub-data stream in a manner corresponding to the first data transmission technology and to receive or send the second sub-data stream separately from the first sub-data stream in a manner corresponding to the second data transmission technology.

In one embodiment, the communication subnetwork comprises an additional network entity, in particular a router, configured to communicate with the radio access entity according to the first aspect.

In one embodiment, the additional network entity is configured to receive the first sub-data stream and the second sub-data stream separately from one another.

In one embodiment, the second communication interface of the radio access entity is configured to communicate with the mobile communication device according to the second aspect.

In one embodiment, the communication subnetwork is a point-to-point communication subnetwork, in particular a slice, in 5G technology.

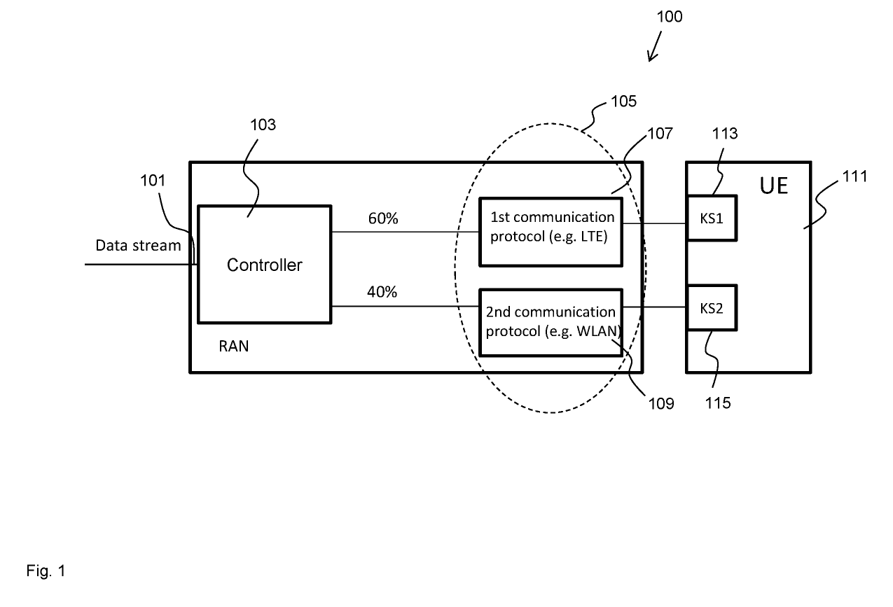

FIG. 1 shows a communication system comprising a radio access entity 100 for communicating with a mobile communication device via a radio access network, wherein the mobile communication device comprises a first communication port which is compliant with a first data transmission technology and a second communication port which is compliant with a second data transmission technology, said radio access entity comprising a first communication interface 101 for receiving a data stream, a processor 103 configured to split the data stream into a first sub-data stream and a second sub-data stream on the basis of a first efficiency level of the first communication port of the mobile communication device 111 shown by way of example and a second efficiency level of the second communication port of the mobile communication device 111, and a second communication interface 105 configured to send the first sub-data stream to the first communication port in a manner corresponding to the first data transmission technology and to send the second sub-data stream to the second communication port in a manner corresponding to the second data transmission technology. The second communication interface 105 may comprise a first communication port 107 which operates according to the first data transmission technology and a second communication port 109 which operates according to the second data transmission technology.

In one embodiment, the data stream travelling to the UE 111 is split on the basis of the data rate or performance of the respective communication ports of the UE 111 that can be achieved by the relevant air interface (LTE, WLAN, etc.).

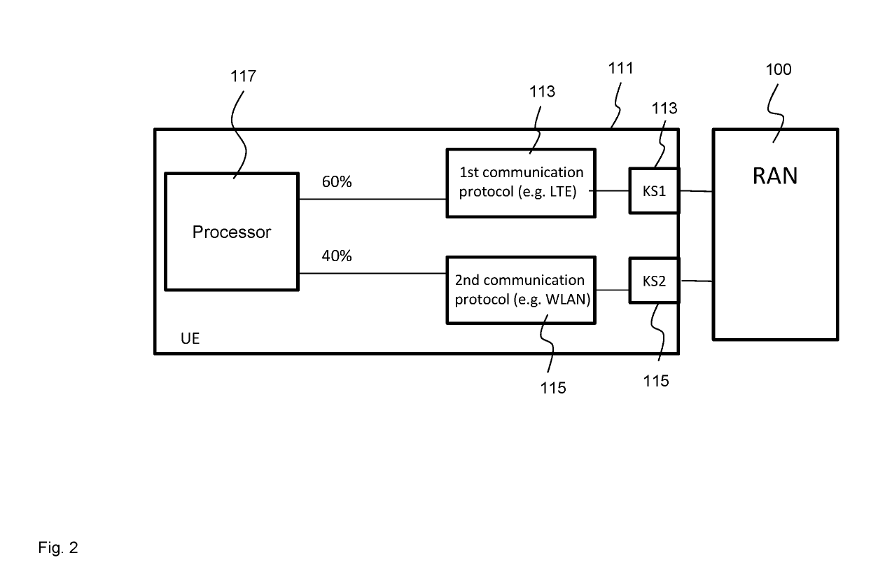

FIG. 2 shows a mobile communication device 111 (UE) comprising a first communication port 113 for sending or receiving a first sub-data stream in a manner corresponding to a first data transmission technology, a second communication port 115 for sending or receiving a second sub-data stream in a manner corresponding to a second data transmission technology, and a processor 117 configured to assemble a data stream from the first sub-data stream and the second sub-data stream, or to split said data stream on the basis of a first efficiency level of the first communication port 113 of the mobile communication device and a second efficiency level of the second communication port 115 of the mobile communication device.

The UE 111 has a plurality of air interfaces (communication ports), such as LTE or WLAN. In one embodiment, the controller or processor 103 of the radio access entity 100 continuously measures the performance of the relevant communication port 113, 115 of the UE 11 or receives the measurement from the UE 111 and splits the data stream accordingly. In the example, the communication port 113 has a higher performance level than the communication port 115 (for example a higher data rate, lower bit error rate, etc.), and therefore the data stream can be split into sub-data streams according to the performance ratio, for example.

The data stream can be split in a packet-oriented manner for example, and therefore the data packets are distributed between the air interfaces 111, 115. The UE 111 assembles the data stream using the data packets in a manner corresponding to the splitting. In this way, the available radio access network (RAN) diversity is used in order to increase the transmission capacity. In the UE 111, the data packets are split according to the performance of the air interfaces 113, 115, as previously mentioned. By analogy with the case of downloading, the subpackets are sent to the RAN comprising the radio access entity 100 using various data transmission technologies. In one embodiment, the communication ports 113, 115 of the UEs 111 can comprise separate antennae for example. Alternatively, the antennae in the UEs 111 can be controlled separated (antenna diversity).

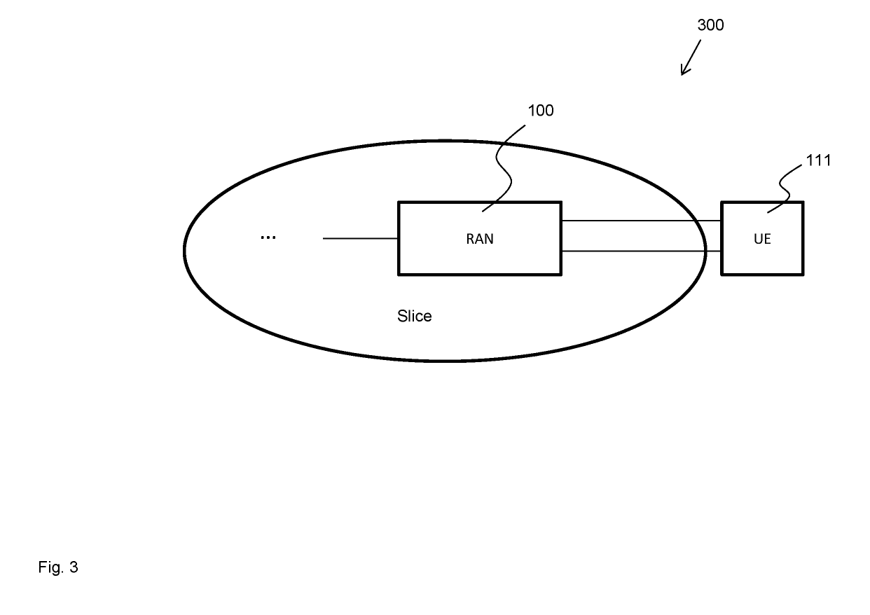

FIG. 3 shows a communication subnetwork 300 in a communication network (not shown) comprising a plurality of subnetworks, comprising the radio access entity 100, wherein the second communication interface 105 is configured to receive or send the first sub-data stream in a manner corresponding to the first data transmission technology and to receive or send the second sub-data stream separately from the first sub-data stream in a manner corresponding to the second data transmission technology.

The communication subnetwork 300 may be a slice of a 5G communication network which brings about the splitting of the data stream into the first sub-data stream and the second sub-data stream or brings about the assembly of the data stream from the first sub-data stream and the second sub-data stream. The RAN slice 300 can be provided as a service and can be made available for each of the UEs 111 that allow for the data splitting. The RAN slice 300 may be given its own slice address/slice identifier.

In one embodiment, each sub-data stream may be given an identifier, as a result of which the data stream can be assembled from the sub-data streams in a simplified manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radio access entity for communicating with a mobile communication device via a radio access network, wherein the mobile communication device comprises a first communication port which is compliant with a first data transmission technology and a second communication port which is compliant with a second data transmission technology, wherein the radio access entity comprises:
a first communication interface for receiving a data stream;
a processor configured to split the data stream into a first sub-data stream and a second sub-data stream on the basis of a first efficiency level of the first communication port of the mobile communication device and a second efficiency level of the second communication port of the mobile communication device; and
a second communication interface configured to send the first sub-data stream to the first communication port in a manner corresponding to the first data transmission technology and to send the second sub-data stream to the second communication port in a manner corresponding to the second data transmission technology.

2. The radio access entity according to claim 1, wherein the processor is configured to split the data stream into the first sub-data stream and the second sub-data stream on the basis of a ratio between the first efficiency level and the second efficiency level.

3. The radio access entity according to claim 1, wherein the first efficiency level and the second efficiency level are data rates, bit error rates or performance indicators.

4. The radio access entity according to claim 1, wherein the data stream comprises a plurality of data packets, and wherein the processor is configured to assign a first number of data packets to the first sub-data stream and to assign a second number of data packets to the second sub-data stream.

5. The radio access entity according to claim 1, wherein the first data transmission technology and the second data transmission technology are one of the following wireless data transmission technologies: Long-Term Evolution (LTE), Universal Mobile Telecommunications Service (UMTS), Global System for Mobile Communications (GSM), High Performance Radio LAN (HiperLAN) or Wireless Local Area Network (WLAN).

6. The radio access entity according to claim 1, wherein the second communication interface comprises a first communication port for sending or receiving the first sub-data stream and a second communication port for sending or receiving the second sub-data stream.

7. The radio access entity according to claim 1, wherein the radio access entity is configured to receive information on the first efficiency level and the second efficiency level from the mobile communication device.

8. The radio access entity according to claim 1, wherein the radio access entity is configured to measure the first efficiency level and the second efficiency level of the mobile communication device.

9. The radio access entity according to claim 8, wherein the measuring the first efficiency level and the second efficiency level of the mobile communication device is performed on the basis of at least one measurement signal.

10. The radio access entity according to claim 1, wherein the radio access entity is assigned to a point-to-point communication subnetwork.

11. The radio access entity according to claim 10, wherein the point-to-point communication subnetwork is a 5G slice.

12. A mobile communication device comprising:
a first communication port for sending or receiving a first sub-data stream in a manner corresponding to a first data transmission technology;
a second communication port for sending or receiving a second sub-data stream in a manner corresponding to a second data transmission technology; and
a processor configured to assemble a received data stream from a received first sub-data stream and a received second sub-data stream or to split a data stream to be sent into a first sub-data stream to be sent and a second sub-data stream to be sent on the basis of a first efficiency level of the first communication port of the mobile communication device and a second efficiency level of the second communication port of the mobile communication device.

13. The mobile communication device according to claim 12, wherein the processor is configured to split the data stream to be sent into the first sub-data stream to be sent and the second sub-data stream to be sent on the basis of a ratio between the first efficiency level and the second efficiency level.

14. A communication subnetwork in a communication network comprising a plurality of communication subnetworks, the communication subnetwork comprising:
a radio access entity, configured to receive or send a first sub-data stream in a manner corresponding to a first data transmission technology and to receive or send a second sub-data stream in a manner corresponding to a second data transmission technology.

15. The communication subnetwork according to claim 14, further comprising:
an additional network entity, configured to communicate with the radio access entity.

16. The communication subnetwork according to claim 15, wherein the additional network entity is a router.

17. The communication subnetwork according to claim 15, wherein the additional network entity is configured to receive the first sub-data stream and the second sub-data stream separately from one another.

18. The communication subnetwork according to claim 14, wherein the communication subnetwork is a point-to-point communication subnetwork.

19. The communication subnetwork according to claim 18, wherein the point-to-point communication subnetwork is a 5G slice.
